(19) United States
(12) Patent Application Publication
(10) Pub. No.: US 2017/0343193 A1
(43) Pub. Date: Nov. 30, 2017

(54) LIGHT SOURCE, BACKLIGHT MODULE AND DISPLAY DEVICE USING SAME

(71) Applicant: HON HAI PRECISION INDUSTRY CO., LTD., New Taipei (TW)

(72) Inventor: YU-HSIANG LAI, New Taipei (TW)

(21) Appl. No.: 15/245,922

(22) Filed: Aug. 24, 2016

(30) Foreign Application Priority Data
May 27, 2016 (CN) 201610360031.7

(51) Int. Cl. F21V 19/00; F21Y 2115/10

(52) U.S. Cl. CPC F21V 19/003; F21Y 2115/10

(57) ABSTRACT

A backlight module includes a backboard and a plurality of light strips on the backboard. The backboard includes a first side portion and a second side portion which flank a middle portion. Each light strip includes a circuit board and a plurality of lamps on the circuit board. The lamps of the at least one light strip in the first side portion and in the second side portion are inclined so as to point to the outside of the two side edges of the backboard. The lamps of the at least one light strip in the middle portion but adjacent to the top and bottom edges of the backboard are inclined so as to point towards a center portion of the backboard.

### FIELD

The subject matter herein generally relates to a light source, and a backlight module and a display device using the light source.

### BACKGROUND

A display device of related art includes a backlight module for emitting light. The backlight module 10 (as shown in FIG. 1) includes a backboard 12 and a plurality of LED bars 11 on the backboard 12. Each LED bar 11 includes a circuit board 111 and a plurality of LEDs 112 on the circuit board 111. The circuit board 111 is coupled to the backboard 12 by a connecting layer 113. The LED bars 11 are parallel to each other and arranged in rows. As is known, intensity of the light at the side portions of the backlight module 10 is weaker than the intensity of the light at the central portion of the backlight module 10. There is a need to improve the intensity of the light emitting at side portions of the backlight module 10. Therefore, there is room for improvement in the art.

### BRIEF DESCRIPTION OF THE DRAWINGS

Implementations of the present technology will now be described, by way of example only, with reference to the attached figures.

FIG. 1 is an isometric view of related art showing a common backlight module.

FIG. 2 is an isometric view of a first exemplary embodiment of a backlight module.

FIG. 3 is an isometric view of a second exemplary embodiment of a backlight module.

FIG. 4 is a cross section view of a display device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

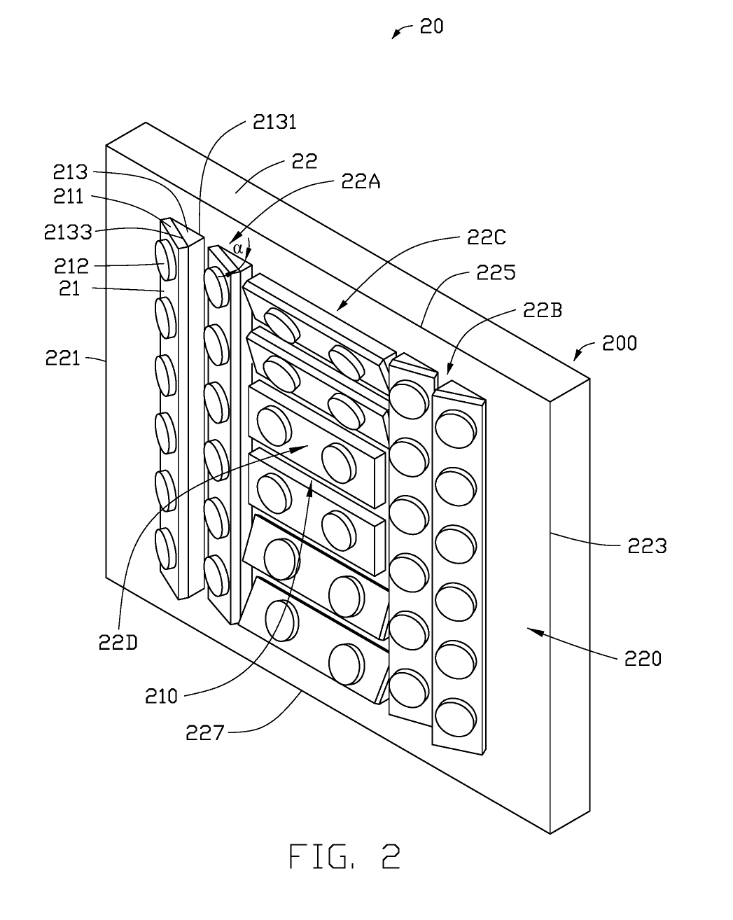

FIG. 2 illustrates a backlight module 20 according to a first exemplary embodiment. The backlight module 20 includes a light source 200 for emitting light. The light source 200 includes a backboard 22 and a plurality of light strips 21 on the backboard 22. The light source 200 comprises of a center area 210 and a peripheral area 220 positioned around a periphery of the center area 210. The plurality of light strips 21 are spaced apart from each other on the backboard 22. The backlight module 20 may further include other elements, such as a reflection film (not shown), a diffusion film (not shown), and a light-enhancing film (not shown).

Each light strip 21 includes a circuit board 211 and a plurality of lamps 212 on the circuit board 211. The lamp 212 may be a common lamp, such as a LED lamp. The plurality of lamps 212 are spaced apart from each other on the circuit board 211. In this embodiment, the lamps 212 on each light strip 21 are arranged along an extending direction of a light strip 21. The circuit board 211 can be rigid or flexible. When the circuit board 211 is rigid, the light strip 21 may be rigid. When the circuit board 211 is flexible, the light strip 21 may be flexible.

Each light strip 21 is coupled to the backboard 22 by a connecting layer 213. The connecting layer 213 includes a first surface 2131 and a second surface 2133 opposite to the first surface 2131. The first surface 2131 is directly attached to the backboard 22, and the second surface 2133 is directly attached to the circuit board 211. The connecting layer 213 may be made of adhesive material. The shape of each circuit board 211 is a quadrilateral. When the first surface 2131 is parallel to the second surface 2133, the lamps 212 on the circuit board 211 are perpendicular to the backboard 22. When the first surface 2131 intersects with the second surface 2133, the lamps 212 on the circuit board 211 are located at an angle of inclination towards the backboard 22.

In this embodiment, the backboard 22 is a rectangle and has a first side edge 221, a second edge 223 opposite to the first side edge 221, a third side edge 223, and a fourth side edge 225 opposite to the third side edge 227. The backboard 22 comprises of a middle portion 22C, a first side portion 22A, and a second side portion 22B. The middle portion 22C comprises of a center portion 22D of the backboard 22. The first side portion 22A and the second side portion 22B are each positioned at a side of the middle portion 22C. The first side portion 22A is positioned between the first side edge 221 and the middle portion 22C, and the second side portion 22B is positioned between the second edge 223 and the middle portion 22C. At least one light strip 21 is positioned in the first side portion 22A, the at least one light strip 21 is positioned in the second side portion 22B, and the at least one light strip 21 is positioned in middle portion 22C.

In this embodiment, as shown in FIG. 2, two first light strips 21 are positioned in the first side portion 22A and extend along a first direction (e. g. parallel to the first side edge 321). Two second light strips 21 are positioned in the second side portion 22B and extend along the first direction. Six third light strips 21 are positioned in middle portion 22C and extend along a second direction which is different from the first direction, for example, the second direction being perpendicular to the first direction.

As shown in FIG. 2, each connecting layer 213 in the first side portion 22A has a thickness gradually increasing along a direction from the first side edge 221 to the middle portion 22C. The light strips 21 positioned on the connecting layer 213 in the first side portion 22A are thus inclined towards the first side edge 221 of the backboard 22, which changes directions of light emitted from the lamps 212 in the first side portion 22A. Therefore, the intensity of light in the peripheral area 220 of the light source 200 is improved. In an example, the arrangement of the first light strips 21 in the first side portion 22A are symmetrical to the arrangement of the second light strips 21 in the second side portion 22B located around the middle portion 22C. Each connecting layer 213 in the second side portion 22B has a thickness gradually increasing along a direction from the second side edge 223 to the middle portion 22C. The light strips 21 in the second side portion 22B are thus inclined towards the second side edge 223 of the backboard 22, which changes directions of light emitted from the lamps 212 in the second side portion 22B. Therefore, the intensity of light in the peripheral area 220 of the light source 200 is improved.

An angle of inclination a is defined between the first surface 2131 and the second surface 2133 of the connecting layer 213 in the first side portion 22A and the second side portion 22B. Each connecting layer 213 in the first side portion 22A has an angle of inclination which is different from the inclination angles of other connecting layers 213 in the first side portion 22A. The connecting layer 213 in the first side portion 22A which is more adjacent to the middle portion 22C has a smaller angle of inclination a. Similarly, each connecting layer 213 in the second side portion 22B has an angle of inclination which is different from the inclination angles of other connecting layers 213 in the second side portion 22B, and the connecting layer 213 in the second side portion 22B which is more adjacent to the middle portion 22C has a smaller angle of inclination.

In other embodiments, the first light strips 21 in the first side portion 22A and the second light strips 21 in the second side portion 22B can be parallel to the third side edge 225, and inclination angles of the first light strips 21 and the second light strips 21 can be the same.

At least one connecting layer 213 in the middle portion 22C which is adjacent to the third side edge 225 has a thickness gradually decreasing along a direction from the third side edge 225 to the center portion 22D. The at least one connecting layer 213 in the middle portion 22C and in the center portion 22D has a constant thickness. The at least one connecting layer 213 in the middle portion 22C which is adjacent to the fourth side edge 227 has a thickness gradually decreasing along a direction from the fourth side edge 227 to the center portion 22D. Thus, at least two third light strips 21 in the middle portion 22C are inclined towards the center portion 22D of the backboard 22, which changes directions of light emitted from the lamps 212 in the middle portion 22C. Therefore, the intensity of light in the center area 210 of the light source 200 is improved.

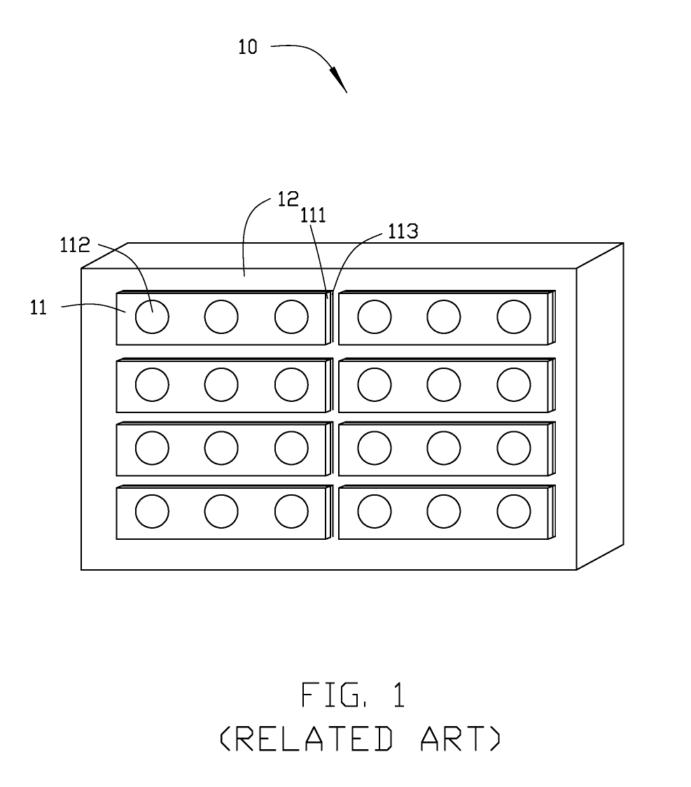

As shown in FIG. 1, in this embodiment, there are two connecting layers 213 in the middle portion 22C which have a thickness gradually decreasing along a direction from the third side edge 225 to the center portion 22D. There are two light strips 21 positioned in the center portion 22D which have a constant thickness. There are two connecting layers 213 in the middle portion 22C which have a thickness gradually decreasing along a direction from the fourth side edge 227 to the center portion 22D.

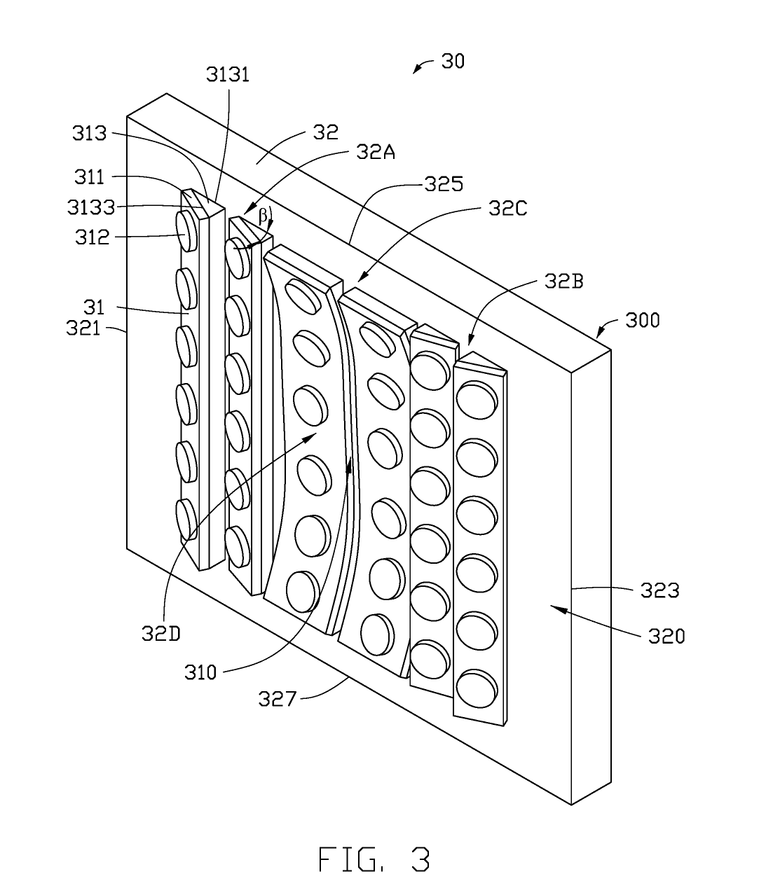

FIG. 3 illustrates a backlight module 30 according to a second exemplary embodiment. The backlight module 30 includes a light source 300 for emitting light. The light source 300 includes a backboard 32 and a plurality of light strips 31 on the backboard 32. The light source 300 comprises of a center area 310 and a peripheral area 320 positioned around a periphery of the center area 310. The plurality of light strips 31 are spaced apart from each other on the backboard 32. The backlight module 30 may further include other elements, such as a reflection film (not shown), a diffusion film (not shown), and a light-enhancing film (not shown).

Each light strip 31 includes a circuit board 311 and a plurality of lamps 312 on the circuit board 311. The plurality of lamps 312 are spaced apart from each other on the circuit board 311. In this embodiment, the lamps 212 on each light strip 21 are arranged along an extending direction of the light strip 21. The circuit board 311 can be rigid or flexible. When the circuit board 311 is rigid, the light strip 31 may be rigid. When the circuit board 311 is flexible, the light strip 31 may be flexible. The lamps 312 can be common lamps in the field, such as LED lamp.

Each light strip 31 is coupled to the backboard 32 by a connecting layer 313. The connecting layer 313 includes a first surface 3131 and a second surface 3133 opposite to the first surface 3131. The first surface 3131 is directly attached to the backboard 32, and the second surface 3133 is directly attached to the circuit board 311. The shape of each circuit board 311 is a quadrilateral. When the first surface 3131 is parallel to the second surface 3133, the lamps 312 on the circuit board 311 are perpendicular to the backboard 32. When the first surface 3131 intersects with the second surface 3133, the lamps 312 on the circuit board 311 are located at an angle of inclination towards the backboard 32.

In this embodiment, the backboard 32 is a rectangle and has a first side edge 321, a second edge 323 opposite to the first side edge 321, a third side edge 323, and a fourth side edge 325 opposite to the third side edge 327. The backboard 32 comprises of a middle portion 32C, a first side portion 32A, and a second side portion 32B. The first side portion 32A and the second side portion 32B are each positioned at a side of the middle portion 32C. The first side portion 32A is positioned between the first side edge 321 and the middle portion 32C, and the second side portion 32B is positioned between the second edge 323 and the middle portion 32C. The middle portion 22C comprises of a center portion 22D of the backboard 22. The at least one light strip 31 is positioned in the first side portion 32A, the at least one light strip 31 is positioned in the second side portion 32B, and the at least one light strip 31 is positioned in middle portion 32C.

In this embodiment, as shown in FIG. 3, two first light strips 31 are positioned in the first side portion 32A and extend along a first direction (e. g. parallel to the first side edge 321). Two second light strips 31 are positioned in the second side portion 32B and extend along the first direction; and two third light strips 31 are positioned in middle portion 32C and also extend along the first direction.

As shown in FIG. 3, each connecting layer 313 in the first side portion 32A has a thickness gradually increasing along a direction from the first side edge 321 to the middle portion 32C. The first light strips 31 in the first side portion 32A are thus inclined towards the first side edge 321 of the backboard 32, which changes directions of light emitted from the lamps 312 in the first side portion 32A. Therefore, the intensity of light in the peripheral area 320 is improved. Each connecting layer 313 in the second side portion 32B has a thickness gradually increasing along a direction from the second side edge 323 to the middle portion 32C. The second light strips 31 in the second side portion 32B are thus inclined towards the second side edge 323 of the backboard 32, which changes directions of light emitted from the lamps 312 in the second side portion 32B. Therefore, the intensity of light in the peripheral area 320 is improved.

An angle of inclination β is defined between the first surface 3131 and the second surface 3133 of one connecting layer 313 in the first side portion 32A and the second side portion 32B. Each connecting layer 313 in the first side portion 32A has an angle of inclination which is different from the inclination angles of other connecting layers 313 in the first side portion 32A. The connecting layer 313 in the first side portion 32A which is more adjacent to the middle portion 32C has a smaller angle of inclination β. Each connecting layer 313 in the second side portion 32B has an angle of inclination which is different from the inclination angles of other connecting layers 313 in the second side portion 32B, and the connecting layer 313 in the second side portion 32B which is more adjacent to the middle portion 32C has a smaller angle of inclination.

In other embodiments, the first light strips 31 in the first side portion 32A and the second light strips 31 in the second side portion 22B can be parallel to the third side edge 325. The inclination angles of the light strips 31 in the first side portion 32A and in the second side portion 32B can also be the same.

At least one connecting layer 313 in the middle portion 32C has a thickness which gradually decreases along a direction from the third side edge 325 to the center portion 22D of the backboard 32. The thickness is then constant across the center portion 22D of the backboard 32, and then gradually increases along a direction from the center portion 22D to the fourth side edge 327. The portions of light strips 31 in the middle portion 32C which are adjacent to the third and fourth side edges 325 and 327 are inclined towards the center portion of the backboard 32. This changes directions of light emitted from the lamps 312 in the middle portion 32C and adjacent to the third and fourth side edges 325 and 327. Therefore, the intensity of light in center area 310 is improved.

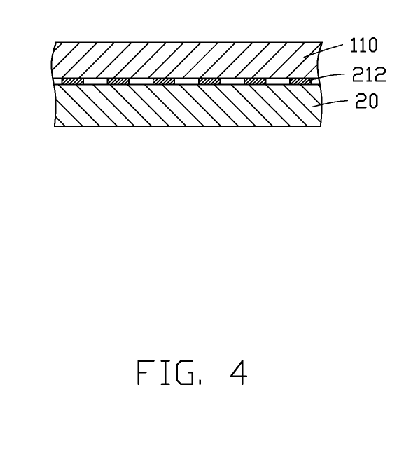

FIG. 4 illustrates a display device 100 using the backlight module 20. The display device 100 includes the backlight module 20 and a display panel 110 stacked on the backlight module 20. The lamps 212 of the backlight module 20 face the display panel 110. The backlight module 20 can also be replaced by the backlight module 30.

The embodiments shown and described above are only examples. Many details are often found in the art such as the other features of an image device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A light source defining a center area and a peripheral area positioned around a periphery of the center area, comprising:
a backboard defining a first side portion, a second side portion opposite to the first side portion, and a middle portion between the first side portion and the second side portion; and
a plurality of light strips on the backboard, each light strip comprising a circuit board and at least one lamp on the circuit board, the plurality of light strips comprising at least one first light strip being positioned in the first side portion, at least one second light strip being positioned in the second side portion, at least one third light strip being positioned in the middle portion;
wherein the lamps of the at least one first light strip are inclined towards a first side edge of the backboard to improve intensity of light in the peripheral area of the light source, the first side edge is adjacent to the first side portion and away from the middle portion; the lamps of the at least one third light strip are inclined towards a center portion of the backboard to improve intensity of light in the center area of the light source.

2. The light source of claim 1, wherein the lamps of the at least one second light strip in the second side portion are inclined towards a second side edge of the backboard to improve intensity of light in the peripheral area of the light source, the second side edge is opposite to the first side edge.

3. The light source of claim 1, wherein the light source comprises a plurality of connecting layers, and each circuit board is coupled to the backboard by one connecting layer.

4. The light source of claim 3, wherein the at least one connecting layer in the first side portion has a thickness gradually increasing along a direction from the first side edge to the center portion of the backboard; and the at least one first light strip is inclined towards the first side edge of the backboard.

5. The light source of claim 3, wherein each first light strip in the first side portion extends along a first direction parallel to the first side edge; and each third light strip in the middle portion extends along a direction perpendicular to the first direction.

6. The light source of claim 5, wherein the at least one connecting layer in the middle portion and adjacent to a third side edge of the backboard has a thickness gradually decreasing along a direction from the third side edge to the center portion of the backboard; the third side edge is coupled to the first side edge; and the at least one third light strip inclines towards the center portion of the backboard.

7. The light source of claim 4, wherein each connecting layer has a first surface attached to the backboard and a second surface attached to the circuit board; an angle of inclination is defined between the first surface and the second surface of one connecting layer; the connecting layers in the first side portion have different inclination angles; and the connecting layer in the first side portion which is more adjacent to the middle portion has a smaller angle of inclination.

8. The light source of claim 3, wherein each first light strip in the first side portion extends along a first direction parallel to the first side edge; and each third light strip in the middle portion extends along the first direction.

9. The light source of claim 8, wherein the at least one connecting layer in the middle portion has a thickness gradually decreasing along a direction from a third side edge to a center portion of the backboard, then keeping constant across the center portion of the backboard, and finally gradually increasing along a direction from the center portion to a fourth side edge of the backboard; the third side edge is coupled to the first side edge and is opposite to the fourth side edge.

10. A backlight module comprising:
a light source defining a center area and a peripheral area positioned around a periphery of the center area, the light source comprising:
a backboard defining a first side portion, a second side portion opposite to the first side portion, and a middle portion between the first side portion and the second side portion; and
a plurality of light strips on the backboard, each light strip comprising a circuit board and the at least one lamp on the circuit board, the plurality of light strips comprising the at least one first light strip being positioned in the first side portion, the at least one second light strip being positioned in the second side portion, the at least one third light strip being positioned in the middle portion;
wherein the lamps of the at least one first light strip are inclined towards a first side edge of the backboard to improve intensity of light in the peripheral area of the light source, the first side edge is adjacent to the first side portion and away from the middle portion; the lamps of the at least one third light strip are inclined towards a center portion of the backboard to improve intensity of light in the center area of the light source.

11. The backlight module of claim 10, wherein the lamps of the at least one second light strip in the second side portion are inclined towards a second side edge of the backboard to improve intensity of light in the peripheral area of the light source, the second side edge is opposite to the first side edge.

12. The backlight module of claim 10, wherein the light source comprises a plurality of connecting layers, and each circuit board is coupled to the backboard by one connecting layer.

13. The backlight module of claim 12, wherein the at least one connecting layer in the first side portion has a thickness gradually increasing along a direction from the first side edge to the center portion of the backboard; and the first light strip inclines towards the first side edge of the backboard.

14. The backlight module of claim 12, wherein each first light strip in the first side portion extends along a first direction parallel to the first side edge; and each third light strip in the middle portion extends along a direction perpendicular to the first direction.

15. The backlight module of claim 14, wherein the at least one connecting layer in the middle portion and adjacent to a third side edge of the backboard has a thickness gradually decreasing along a direction from the third side edge to the center portion of the backboard; the third side edge is coupled to the first side edge; and the at least one third light strip are inclined towards the center portion of the backboard.

16. The backlight module of claim 13, wherein each connecting layer has a first surface attached to the backboard and a second surface attached to the circuit board; an angle of inclination of one light strip is defined between the first surface and the second surface of one corresponding connecting layer; the connecting layers in the first side portion have different inclination angles; and the connecting layer in the first side portion which is more adjacent to the middle portion has a smaller angle of inclination.

17. The display device of claim 12, wherein each first light strip in the first side portion extends along a first direction parallel to the first side edge; and each third light strip in the middle portion extends along the first direction.

18. The backlight module of claim 17, wherein the at least one connecting layer in the middle portion has a thickness gradually decreasing along a direction from a third side edge to a center portion of the backboard, then keeping stable corresponding to the center portion of the backboard, and finally gradually increasing along a direction from the center portion to a fourth side edge of the backboard; the third side edge is coupled to the first side edge and is opposite to the fourth side edge.

19. A display device comprising:
a backlight module;
the backlight module comprising:
a light source defining a center area and a peripheral area positioned around a periphery of the center area, the light source comprising:
a backboard defining a first side portion, a second side portion opposite to the first side portion, and a middle portion between the first side portion and the second side portion; and
a plurality of light strips on the backboard, each light strip comprising a circuit board and at least one lamp on the circuit board, the plurality of light strips comprising at least one first light strip being positioned in the first side portion, at least one second light strip being positioned in the second side portion, at least one third light strip being positioned in the middle portion;
wherein the lamps of the at least one first light strip are inclined towards a first side edge of the backboard to improve intensity of light in the peripheral area of the light source, the first side edge is adjacent to the first side portion and away from the middle portion; the lamps of the at least one third light strip in the middle portion are inclined towards a center portion of the backboard to improve intensity of light in the center area of the light source.
